(19) United States
(12) Patent Application Publication
(10) Pub. No.: US 2005/0281437 A1
(43) Pub. Date: Dec. 22, 2005

(54) Talking paper

(76) Inventors: Renate Fruchter, Los Altos, CA (US); Zhen Yin, Stanford, CA (US); Subashri Swaminathan, Stanford, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/131,935

(22) Filed: May 17, 2005

Related U.S. Application Data
(60) Provisional application No. 60/572,243, filed on May 17, 2004.

(51) Int. Cl. G06K 9/00

(52) U.S. Cl. 382/113

(57) ABSTRACT

The present invention tightly integrates and significantly leverages media capture systems to realize a ubiquitous collaborative multi-user environment, referred to as TalkingPaper, taking full advantages of what each unique medium can offer and further enhancing their respective functions and utilities. The invention comprises a paper-pen based knowledge capture subsystem A and a knowledge processing subsystem B. A user uses a subsystem A compliant pen to sketch on a piece of subsystem A enabled paper. The sketching activity, speech and gesture are recorded by the pen, which sends the captured data to a multi-threaded application server of subsystem B for further processing. The server converts and indexes the data to associate and synchronize each line stroke with corresponding audio time frames and enable the content interaction. Thus, users can easily find, select, and replay a session with synchronized speech, text, and video to understand the rationale behind certain ideas or decisions.

### CROSS-REFERENCE TO RELATED APPLICATIONS

The present application claims priority from the provisional patent application No. 60/572,243, filed May 17, 2004, which is incorporated herein by reference. The present application also relates to the U.S. patent application Ser. No. 10/824,063, filed Apr. 13, 2004, which is a continuation-in-part application of the U.S. patent application Ser. No. 09/568,090, filed May 12, 2000, U.S. Pat. No. 6,724,918, issued Apr. 20, 2004, which claims priority from the provisional patent application No. 60/133,782, filed on May 12, 1999, all of which are incorporated herein by reference.

### FIELD OF THE INVENTION

The invention generally relates to multimodal information capturing and reuse. More particularly, it relates to a method, system and apparatus integrating analog paper, digital multimedia, and communications for paper-pen based knowledge capture and reuse.

### DESCRIPTION OF THE BACKGROUND ART

With all the advances in computing today people still prefer using pen and paper to capture and communicate ideas. Unfortunately, paper and paper-based media are hard to share, exchange, and re-use hand written/drawn ideas or information. They do not capture the discourse among users. The moment the paper napkin is lost or the whiteboard is erased, gone also are the ideas that they once carried.

Furthermore, paper is difficult to modify or edit. It can be very expensive to distribute and/or archive. Depending upon the material, it can also be quite fragile and not suitable for re-use.

Digital documents, on the other hand, are easy to edit, duplicate, index, sort, search, share, archive, and relatively inexpensive to distribute.

However, many studies have shown that paper has a number of affordances that cannot be easily replaced with existing digital media. These affordances, for example, easy navigation, concurrent reading of multiple documents, easy and direct annotation, high-resolution viewing of both overview and details at the same time, tactile feedback, two-handed interaction, easy to fold or roll and carry around, highly developed and well accepted in social conventions and processes, are expected to keep paper media on the market.

In order to capture, share and reuse relevant content (i.e., knowledge in context) from analog activities such as paper and pencil sketches and verbal discourse, it is critical to convert such externalized tacit knowledge into digital symbolic representations that could facilitate future sharing, searching, replay, and reuse of the tacit knowledge.

What is needed, therefore, is a multi-user paper-based knowledge capture and reuse environment that integrates the best of all worlds, combining analog paper, digital multimedia, and communications to empower team members, project stakeholders, and the like and to engage them in productive collaborative synchronous and asynchronous teamwork. The present invention addresses this need.

### SUMMARY OF THE INVENTION

Accordingly, it is the primary object of the present invention to integrate analog paper, digital multimedia, and advanced communications and knowledge capture and reuse technologies and systems in a seamless, efficient, effective, and user friendly fashion, taking full advantages of what each unique medium can offer and further enhancing their respective functions and utilities.

This primary object is achieved in a truly horizontal technology hereinafter referred to as TalkingPaper™ (TP). TalkingPaper transforms tacit knowledge, such as dialogues, handwritten notes, and paper and pencil sketches, into digital symbolic representations by converting the unstructured, informal content into digital audio and sketch objects that can be streamed on-demand over the Web to multiple users for rapid knowledge transfer and decision-making. In this regard, TalkingPaper particularly addresses the increasingly complex communication, coordination, and cognition needs of paper-intensive, collaborative, multi-user projects in which stakeholders often engage in dialogue and sketching activities in three dimensional spaces—multiple users, multiple documents, and multiple pens.

TalkingPaper supports each of the activities identified while observing the interaction among the stakeholders during a collaborative event such as a permit approval process. As individuals (stakeholders, designers, etc.) collaborate on a project, knowledge is created. TalkingPaper is developed based on the empirical observations that knowledge capture, sharing, and reuse are key steps in the knowledge life cycle. Accordingly, knowledge should be captured, indexed, and stored in an archive such that, at a later time, users can retrieve it from the archive and reuse and/or refine it.

TalkingPaper is built on several innovative technologies, including the RECALL™ technology, hereinafter referred to as RECALL, disclosed in the above-referenced U.S. Pat. No. 6,724,918, and the Anoto® technology, hereinafter referred to as ANOTO, developed by the Anoto Group AB (formerly C Technologies) of Sweden. RECALL facilitates transparent and cost effective capture, sharing, and re-use of knowledge in informal media, such as sketching, audio, and video. ANOTO captures and converts handwritten text to digital media, putting the power of digital communications into seemingly ordinary pen and paper.

TalkingPaper thus comprises two subsystems (modules): a paper-pen based knowledge capture module (ANOTO) and a knowledge index and archive module (RECALL). As an example, in a TalkingPaper session, a user uses ANOTO compliant pen to sketch an object on a piece of paper that is enabled with the Anoto® pattern. Any line stroke drawn on the paper and its start and end coordinates recorded by the pen. The pen sends the line stroke data to a TalkingPaper Application Service Handler (ASH) for further processing. The ASH converts the line stroke data into TalkingPaper objects, through which TalkingPaper is able to associate and synchronize each line stroke with corresponding audio time frames and to enable content interaction. A TalkingPaper Web server archives, shares, and streams TalkingPaper sessions.

TalkingPaper tightly integrates two advanced technologies to provide a ubiquitous paper-pen based knowledge capture and reuse environment. TalkingPaper captures information much like regular paper and can be distributed the same. Since the captured information is digitized, index, and stored, it can be easily managed, duplicated, and distributed digitally and efficiently. Not only TalkingPaper captures information as a whole, it also captures, indexes, synchronizes, and replays individual sketching activities, drawing/writing movements, and associated multimedia information. TalkingPaper provides, shares, and utilizes rich information content in an effective, efficient, convenient, and user-friendly fashion. TalkingPaper thus would be highly desirable in architecture, design, manufacturing, engineering, construction, high-tech, healthcare, automotive, fashion, education, etc.

Still further objects and advantages of the present invention will become apparent to one of ordinary skill in the art upon reading and understanding the detailed description of the preferred embodiments and the drawings illustrating the preferred embodiments disclosed herein.

### BRIEF DESCRIPTION OF THE FIGURES

FIG. 1 shows (a) a single user scenario and (b) a multi-user scenario where embodiments of the present invention may be implemented.

FIG. 2 shows the three-dimensional problem space that defines a spectrum of scenarios.

FIG. 3 illustrates the spectrum of scenarios from reflection-in-action to reflection-in-interaction.

FIG. 4 illustrates the first embodiment of the present invention, with sketch and voice capture and synchronization.

FIG. 5 illustrates exemplary scenarios with different capture and replay devices.

FIG. 6 illustrates the second embodiment of the present invention, with sketch, voice, and document capture, indexing and synchronized replay.

FIG. 7 is a screenshot of a user interface for the TalkingPaper Printing Module.

FIG. 8 shows a user interface for the Collage Capture functionality.

FIG. 9 is a screenshot of a user interface for the Save Database functionality.

FIG. 10 is a screenshot of a user interface for the Page Settings functionality.

FIG. 11 is a screenshot of a user interface for the Print Preview functionality.

FIG. 12 is a screenshot of a user interface for the Print functionality.

FIG. 13 illustrates the object class hierarchy for the printing phase of the present invention.

FIG. 14 illustrates an overview of the capture post process and replay modules.

FIG. 15 illustrates how to select/define an area for printing.

FIG. 16 is a screenshot of a user interface for TalkingPaper Client.

FIG. 17 illustrates the third embodiment of the present invention, implementing a client-server scenario with a single document, a single user, and a single pen.

FIG. 18 illustrates the TalkingPaper Client object class hierarchy, in order of call hierarchy.

FIG. 19 illustrates the TalkingPaper Server object class hierarchy, in order of call hierarchy.

FIG. 20 illustrates the fourth embodiment of the present invention, implementing a multiple clients-server scenario with a single document, a single user, and a single pen.

FIG. 21 are snapshots of a TalkingPaper session being replayed via a browser application embedded with a media player.

FIG. 22 illustrates the fifth embodiment of the present invention, implementing a multiple clients-server scenario with a single document, multiple users, and multiple pens.

FIG. 23 is an overview of the system and components for scenarios involving multiple pens.

FIG. 24 is an overview of the clock synchronization solution according to the invention.

FIG. 25 illustrates the clock synchronization solution for multiple pens.

FIG. 26 illustrates the sixth embodiment of the present invention, implementing a multiple clients-server scenario with multiple documents, multiple users, and multiple pens.

### DESCRIPTION OF THE INVENTION

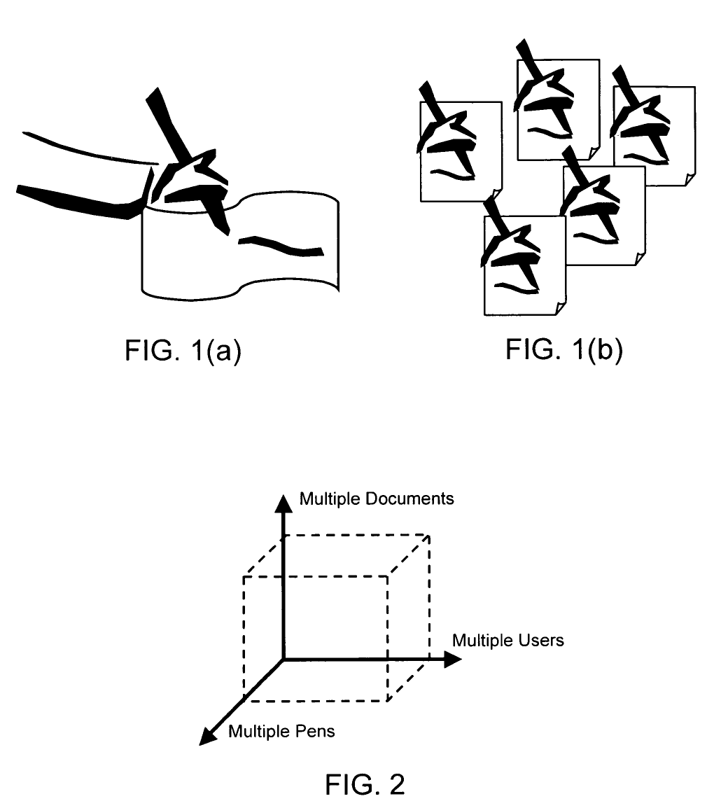

FIG. 1(a) shows a scenario in which a single user sketches and writes on a piece of paper. This could be a professional expert (e.g., architect, engineers) making a note about a new idea or tracing over blueprints to understand all the intricacies of the drawings.

FIG. 1(b) shows a scenario in which several individuals (participants), each representing a specific domain expertise or perspective, annotate and correlate issues across multiple documents. This could be stakeholders and/or experts from different disciplines gather around a large meeting desk with multiple blueprints and other documents (e.g., calculations, spreadsheets, etc.) that they annotate, sketch on, correlate to identify problems, discuss key issues, make recommendations, and request changes.

In both scenarios, the paper documents with sketches and annotated drawings are filed away, perhaps in a shoebox for future reference and reuse. To search and find relevant material this way, one would have to sort through the entire paper archive, which is very time-consuming and highly inefficient.

Moreover, the paper archive stores information in a ‘what-you-see-is-what-you-get’ fashion.

All the discourse, arguments, and rationale (contextual information) behind sketches and handwritten notes, etc. are not captured. The lack of contextual information likely leads to (1) the need for further clarifications and (2) delays in the decision-making process and project progress.

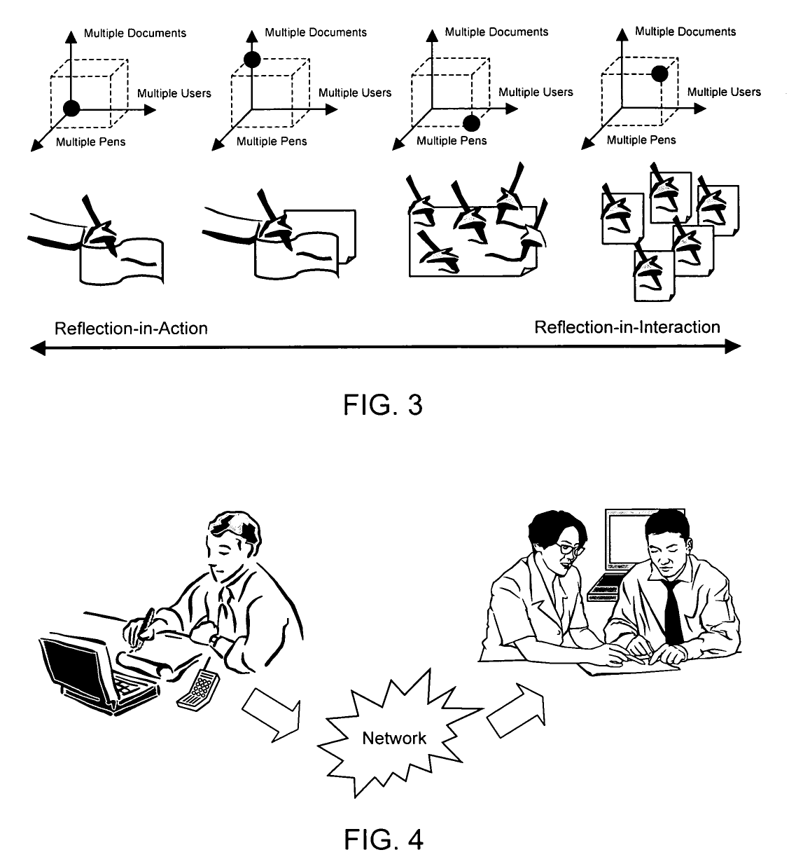

FIG. 2 illustrates the three-dimensional problem space—multiple users, multiple documents, multiple pens—that defines a spectrum of scenarios in which the stakeholders engage in dialogue and sketching activities. As illustrated in FIG. 3, these scenarios include:
reflection-in-action done by one expert with one pen annotating one paper document;
reflection-in-action done by one expert with one pen annotating and correlating multiple paper documents to more complex;
reflection-in-interaction engaging multiple experts, each with his/her own pen annotating and correlating a single shared paper document; and
reflection-in-interaction engaging multiple experts, each with his/her own pen annotating and correlating multiple shared paper documents.

An advantage of the invention is that TalkingPaper is a truly horizontal technology, applicable to all of the above scenarios. With TalkingPaper, dialogue and paper & pencil sketches, and/or joint annotation of one or multiple shared paper documents (e.g., blueprints) are conveniently captured, timely processed, appropriately indexed, and accurately converted into digital objects. These digital audio-sketches are synchronized with corresponding documents stored in a database for future contextual search, retrieval/replay, and reuse based on sketch, annotation of document, keyword, and/or participant.

FIG. 4 illustrates the first embodiment of TalkingPaper, focusing on capture, indexing, synchronization and reply of discourse (voice) and sketch on ANOTO paper. This embodiment exemplifies the first scenario illustrated in FIG. 3—reflection-in-action—where there is one expert, one document, and one pen.

TalkingPaper comprises an interactive graphical user interface (GUI) implemented with enhanced RECALL functionalities. Readers are directed to the above-referenced U.S. Pat. No. 6,724,918 for more detailed teachings on the proprietary RECALL technology.

The TalkingPaper GUI provides a sketch window that functions as a digital canvas onto which a user can sketch free hand drawings or writings. A 2D CAD object maybe imported as a background image on the canvas. One or more users can annotate the imported image with handwritings and/or a plurality of sketch objects.

The TalkingPaper GUI also provides a color pallet and a plurality of functionality buttons such as Undo, ClearSketch, Loadlmage, Clearlmage, LoadPPT, 2D/3D, SubPage, Select, Merge, Trace, Overlay, Screenshot, and Paceshot. Additional functionalities can be readily implemented. The necessary programming techniques are known in the art.

The TalkingPaper GUI integrates a search functionality that enables a user to search/select a keyword in a search or text window. Upon selection, an appropriate TalkingPaper session begins to replay in another window from the point when the latest sketch object was drawn before the corresponding keyword was spoken. The captured sketches or sketch objects might be replayed in sync with the captured correlated audio. In addition, text corresponding to the audio can also be transcribed and replayed synchronously in a text window of the GUI. With this GUI, a user can decide and select when, how much, and what captured content rich multimedia information is to be precisely replayed.

ANOTO allows handwritten text to be transmitted from paper to digital media. An ANOTO-compliant pen (hereinafter referred to as the “pen” or “digital pen”) is capable of capturing images and uploading them to a server. Anyone with a proper authorization can subsequently access and/or download the digital image from the server.

The digital pen looks and feels like a regular pen but differs from a regular pen to comply with the ANOTO technology. The digital pen writes on ordinary paper printed with a unique pattern that is almost invisible to the naked eye, which perceives the printed paper as a slightly off-white color. The proprietary pattern consists of very small dots having a nominal spacing of 0.3 mm (0.01 inch). The pattern of dots allows dynamic information coming from the digital camera in the digital pen to be processed into signals representing functionality, writing, and drawing. ANOTO-compliant pens are currently produced by Sony-Ericsson, Nokia, Logitech, and Maxwell, each of which is a respectively owned trademark.

By using ANOTO-compliant paper and pen, any line stroke drawn on the paper and its start and end coordinates are recorded by the digital pen. Subsequently, the digital pen communicates with a Network Paper Look Up Service (NPLS) server. This service is located at an ANOTO Network Service Server. The TalkingPaper Application Service Handler (ASH) is registered with the ANOTO NPLS. This enables the digital pen to know where it should send data.

An exemplary detailed communication procedure is described below:
The digital pen sends an ASH look up request to a wireless device such as a cell phone via a wireless communication protocol such as the Bluetooth.
The cell phone forwards this request to the NPLS server through the GPRS (General Packet Radio Service) network.
Through the same bidirectional, wireless communication channel, the NPLS sends back to the digital pen an appropriate network address, e.g., an uniform resource locator (URL) address of the TalkingPaper ASH.
The digital pen sends the line stroke data to the TalkingPaper ASH.

The TalkingPaper ASH enables the knowledge indexing and archival of TalkingPaper.

Digital line strokes defined by ANOTO are converted into TalkingPaper data so that TalkingPaper is able to render those line strokes on the digital canvas. Digital line strokes defined by ANOTO are in XML format. Thus, the first step involves extracting each line stroke definition and its corresponding timestamp from XML files.

In the second step, a TalkingPaper object is initialized for each line stroke. Both the timestamp and the line stroke coordinates are used to initialize this object. Next, these objects are put into the TalkingPaper data structure, through which TalkingPaper is able to associate and synchronize each line stroke with corresponding audio time frames and enable the content interaction.

Through its integrated subsystems, TalkingPaper offers users several communications channels, including synchronized video/audio and sketch, to generate design concepts. Users interact with seemingly ordinary paper and pen to draw sketches and/or jot down ideas in an environment that is familiar to or exactly the same as their normal working settings. A content rich knowledge capture process can start or stop as easy as selecting, e.g., clicking on, a designated area on the ANOTO-enabled paper. The knowledge evolved through these channels is indexed by TalkingPaper. Further information retrieval is made available by other TalkingPaper modules.

In an industry setting, designers should print their AutoCAD® drawings on ANOTO-enabled paper. This way, anytime when they markup the drawings and want this process to be captured, they would use an ANOTO-compliant digital pen to start the gesture/speech/sketch recorder, e.g., touch or “click” a particular box or “button” printed on the paper. Thereafter, users can freely discuss ideas, markup the printed drawings, and/or add sketches/writings onto the paper. This is referred to as a TalkingPaper session.

At the end of this session, the same box or “button” is clicked again to stop the recorder and begin the (manual or automatic) transfer of data captured during the session. That is all what is needed from the user or users. Data captured are post-processed by TalkingPaper, synchronizing the sketch objects with the audio/video stream to enable later retrieval and synchronized replay.

In an ongoing project, users often want or need to revisit the design evolution. With TalkingPaper, they no longer need to go through many paper sketches or dig into their shoebox or memory to recall a discussion. They can simply run the TalkingPaper GUI, which may be implemented with a Web browser application, and search with keywords related to the discussion.

In response to the query, the TalkingPaper GUI displays one or more relevant TalkingPaper sessions with correlated sketch, speech transcript, and video. The users can easily find and select the most relevant session and replay the selected session with synchronized speech, text, and video in order to understand the rationale behind certain ideas or decisions.

A key advantage of TalkingPaper is that it provides a new way of effective communication and expands the usefulness of its subsystems (i.e., RECALL and ANOTO) beyond their respective utility. As a standalone system, RECALL is capable of accurately capturing and replaying informal knowledge creation activities. However, RECALL requires certain hardware compatibility, e.g., a computer with an appropriate input device such as a touch panel, Tablet PC, SmartBoard, etc. This requirement presents an obstacle to designers whose normal work settings involve pen and paper.

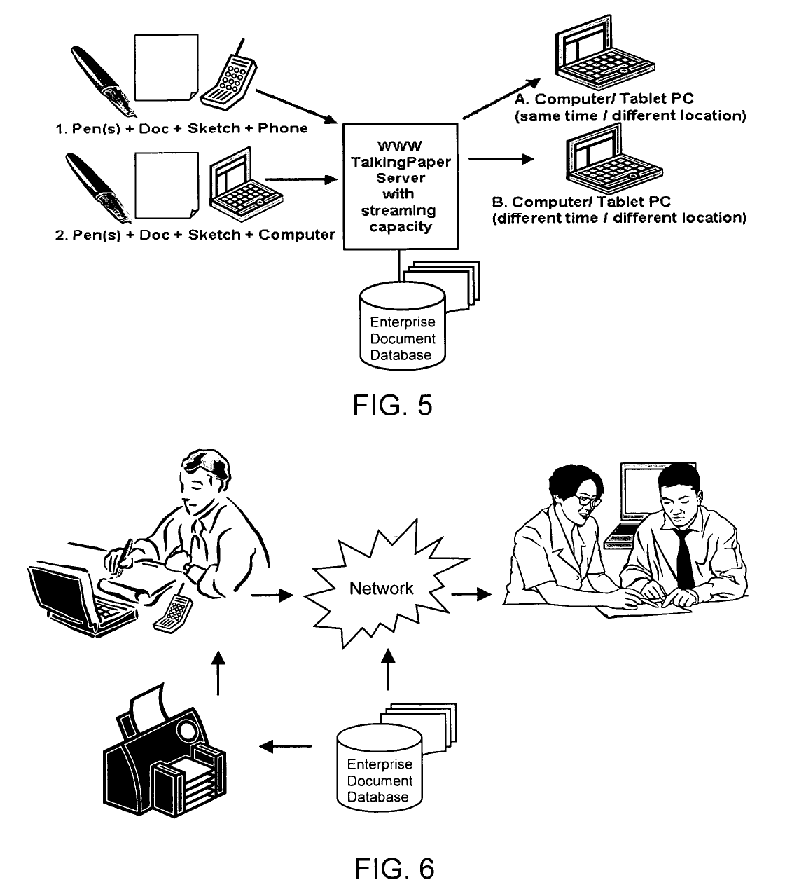

On the other hand, as a standalone system, ANOTO provides a paper-based knowledge capture infrastructure. However, ANOTO indiscriminately captures the whole and does not capture individual line strokes—much like taking a snapshot of drawings and not the drawing movements, resulting a static representation of sketches in digital format. These snapshots are captured out of context without any background information, explanation, and/or discussion regarding the sketches. TalkingPaper overcomes these limitations and can work with a variety of capture and replay devices, such as laptop computers, cell phones, table PCs, etc., as shown in FIG. 5. This useful flexibility of TalkingPaper applies to all of the embodiments disclosed herein.

FIG. 6 illustrates the second embodiment of TalkingPaper, with sketch-voice-document capture, indexing and synchronized replay. Like the first embodiment, this embodiment implements the first scenario illustrated in FIG. 3 where there is a single user, a single document, and a single digital pen.

This embodiment of TalkingPaper captures, indexes, and synchronizes documents from an enterprise database that are printed on ANOTO paper, annotated with a digital pen, transmitted wirelessly (e.g., via Bluetooth) to a cell phone and then to the ANOTO paper look up service (PLS) and the TalkingPaper server, and synchronized with the voice captured on a laptop or desktop PC client.

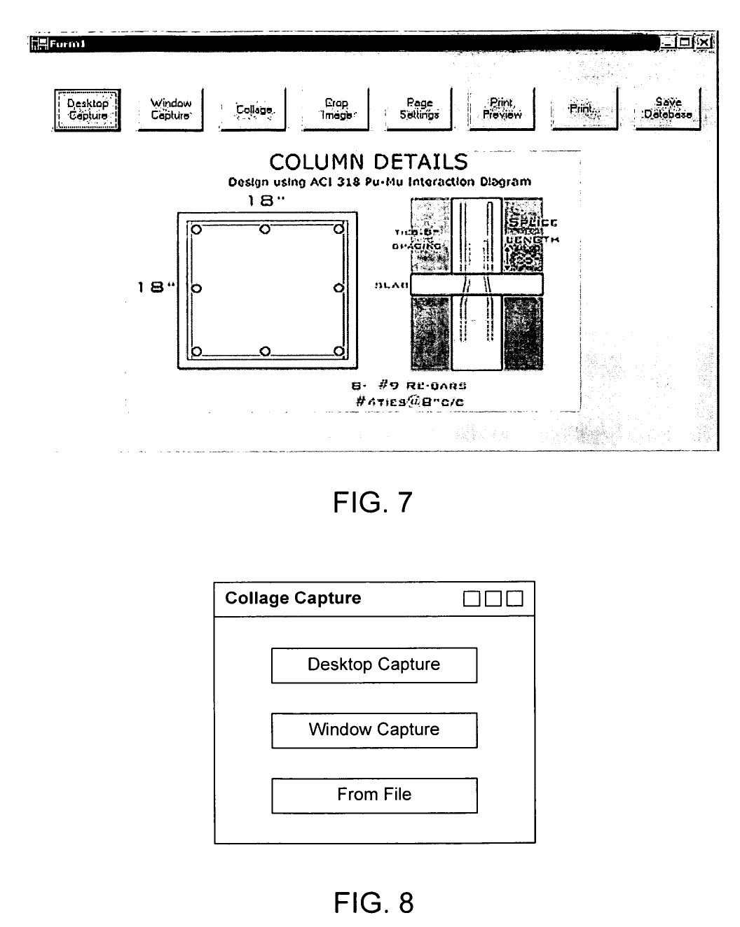

FIG. 7 is a screenshot of a user interface for the TalkingPaper Printing Module with a plurality of functionality buttons and a document viewer. In FIG. 7, a document entitled “COLUMN DETAILS” is shown in the document viewer. The TalkingPaper Printing Module enables a user to print a document from the enterprise database on to the ANOTO paper. It is independent of the type of document user opens to print. It can capture a screenshot of any portion of the document to be printed as an image and provides an option to create a collage of images.

These images are saved in a document database along with the TalkingPaper Session name with which this image is associated. A TalkingPaper post processing application retrieves the corresponding image from the database for the post processing. This TalkingPaper module is developed in the NET development environment to facilitate printing documents not only from laptops, desktops but also from webpads and PDAs.

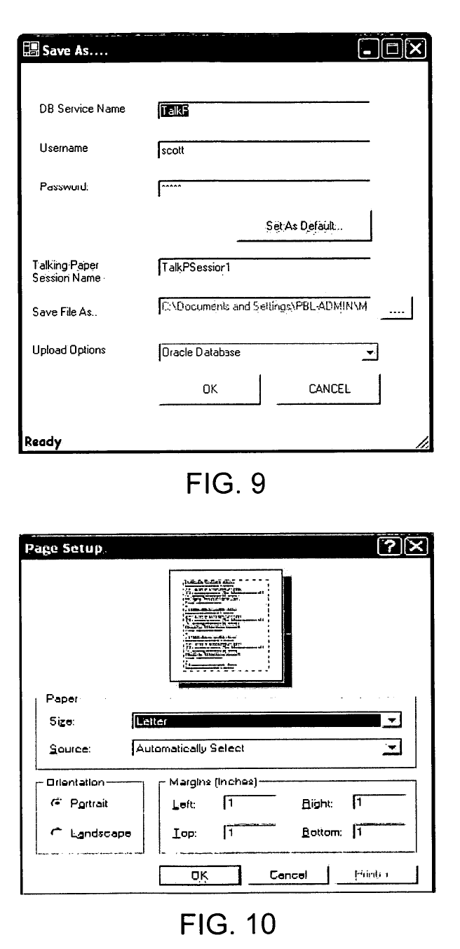

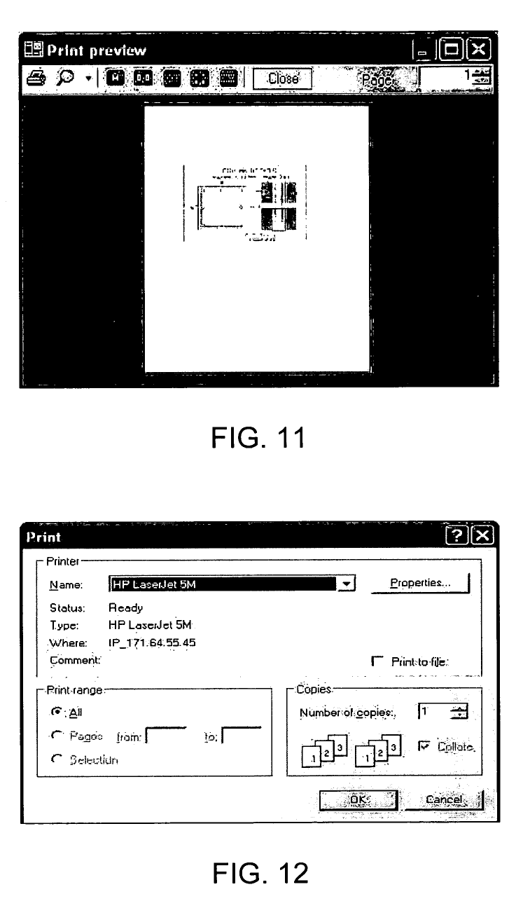

The TalkingPaper Client Printing Module comprises the following functionalities:
Desktop Capture for capturing the entire desktop in a screenshot. To capture a document image using the “Desktop Capture” functionality, open and expand on the desktop any document to be printed. A notification pops up while the system is capturing. The screenshot is then inserted in the document viewer.
Window Capture for capturing an application window in a screenshot. To capture a document image using the “Window Capture” functionality, select any application window that is open on the desktop. A notification pops-up while the system is taking a screenshot of the application window. This screenshot is then inserted in the document viewer.
Crop Image for resizing any captured image. Once the “Crop Image” button is selected, the user is asked to mark two points on the captured image. These points define the size (dimension) of the cropped image. The new image will be scaled based on the selected size and displayed in the document viewer.
Collage for creating a collage of selected documents for printing. After the “Collage Image” button is selected, a dialog box comes up and provides the options (Desktop Capture, Window Capture, and From File) to load a new image, as shown in FIG. 8. After selecting one of the above options, the user is asked to mark points in the document viewer that define the size and location of the new image in the collage. The new image will be scaled based on the selected size and a collage of any previous image along with new image will be displayed in the document viewer.
Save Database for saving the captured image to a document database for TalkingPaper post processing. All the input fields in FIG. 9 must be filled: the Database (DB) Server Name, the login Username and Password for the database, the TalkingPaper session name, and the type of database. The “OK” button will not be enabled until all the information is entered. After selecting the “OK” button, if the record is inserted successfully in the database, a confirmation message will be displayed.
The Print functionality has three options:
1. Page Setup, shown in FIG. 10, facilitates setting the boundaries of paper for printing.
2. Print Preview, shown in FIG. 11, provides a preview of a document image to be printed in a specified location on a page before it is printed.
3. Print Interface, shown in FIG. 12, allows a user to select a specific printer and the number of copies to be printed.

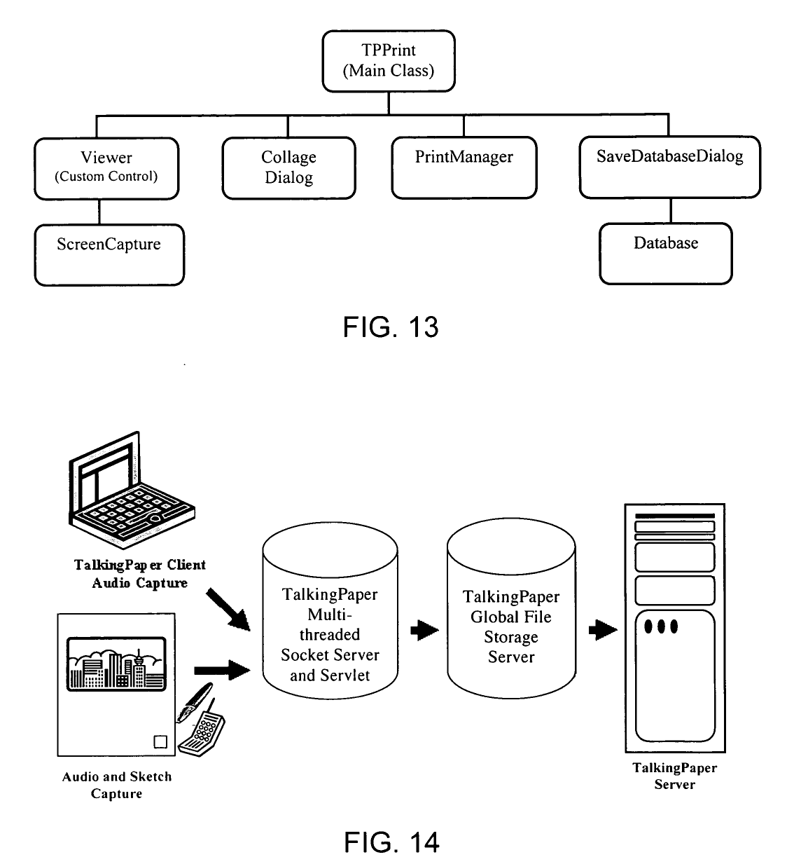

FIG. 13 illustrates the object class hierarchy for the TalkingPaper printing phase. TPPrint is the main control class and contains GUI components for the TalkingPaper printing phase of the client. The GUI components include the C# “Button” API like DesktopCapture, WindowCapture, Collage, CropImage, PageSettings, PrintPreview, Print and SaveDatabase. It uses C# events to communicate with other dialog boxes like Collage Dialog. For instance, the collage dialog box can inform the TPPrint object about its status when it is capturing or finished capturing an image. TPPrint defines functions to handle these events and take appropriate actions.

Viewer is defined and developed as a user custom control specified for the TPPrint GUI. It encompasses a single C# system component (PictureBox). It provides functionalities to set layout, scroll or center the captured image in the document viewer. It also provides functionality to handle all the mouse events especially for the “Crop Image” and “Collage” functionalities when points are marked for resizing the image or placing a new image.

ScreenCapture facilitates the capture of images that have the size of a desktop or window. This class has helper classes, e.g., User32 and GD132, which contain Windows User32 and gdi32 API used for windows programming. User32 is a module that contains Windows API functions related the Windows user interface (Window handling, basic UI functions) and gdi32 contains Windows API functions for the Windows GDI (Graphical Device Interface) which assists windows in creating simple 2-dimensional objects. The ScreenCapture object first gets a handle (pointer) to the window to be captured and creates a memory buffer for it. Using the GetDevice it first gets the width/height of the window to capture, then it creates a bitmap of the image on the screen and copies it into the memory buffer. This memory buffer is then saved into a jpg image file.

Collage Dialog facilitates to create a collage of images. It loads an image using either “Desktop Capture” or “Window Capture” mechanism which uses the ScreenCapture mechanism described above to obtain a bitmap of the window under consideration. It allows users to load images using the C# API “File Dialog”. The user can browse the local file system and select a file to add to his/her collage.

SaveDatabaseDialog contains all the GUI components described above to store the image into the Database. It communicates using C# events with the Database class, which provides the functionality to store images in a database.

Database provides an interface to connect and store TalkingPaper documents to an enterprise document database using, e.g., the C# System.Data.OracleClient API. After connecting to the database, the Database class creates a new command which stores the Structured Query Language (SQL) query. The Database class then reads the image file into the memory buffer and executes the command which stores the image as SQL Binary Large Object (BLOB) along with the session name and the timestamp of the image into the database.

PrintManager manages the page settings and printing of the document using, e.g., the C# System.Drawing.Printing API. For printing, first a “PrintDocument” is created, which represents the object that sends output to the printer. A call is then made to the “Print” method which in turn invokes the Print Page event handled by the “prepare” method defined in the PrintManager. PrintManager provides a method that handles this event and takes appropriate actions to print the document. PrintManager also handles the page settings before printing any page. This could be done by constructing an instance of the System.Drawing.Printing.PageSettings class in the C# API. This allows the user to change the settings of the page. The PrintManager further provides a function handler for the events thrown by PageSettings class, which captures the user changes and modifies the “PrintDocument” accordingly. PrintManager also provides a print preview mechanism using, e.g., the System.Windows.Forms.PrintPreviewDialog. It provides a handler for the events thrown by the PrintPreviewDialog which copies the specified document into a “Print Document” and assigns this object to the “PrintPreviewDialog.”

FIG. 14 shows an overview of the capture post process and replay modules. Devices used in this example includes an ANOTO-complaint digital pen, a Blue-Tooth enabled cellular phone, and Anoto® Digital Paper, which a programmable paper where each area on the paper has been programmed to perform a certain task. We have designed and defined the various areas of the page and stored these definitions in a PAD file. The area of the paper is divided into one large area called the “Drawing Area” and one relatively smaller area which store the “pidgets” (action buttons). The following pidgets are currently defined in the PAD file:
a. Send Pidget: To send all the stroke information to a TalkingPaper Server.
b. Send via Phone Pidget: To send the stroke information via a cell phone over the cellular network.
c. Send via PC Phone Pidget: To send the stroke information via a PC cell phone over the Local Area network using the Anoto emulator.
d. Select Device Pidget: To switch between send modes.

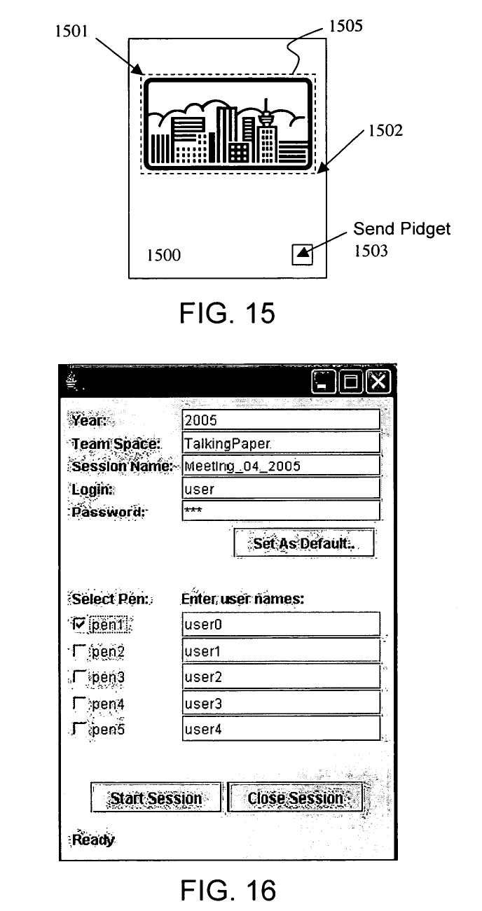

The scenario begins with the user defining the boundaries of a print area for a document of interest. Referring to FIG. 15, this is done by selecting the top left corner 1501 and the bottom right corner 1502 on paper 1500 to define a print area 1501. This enable synchronization of the document with the voice and sketch or annotation during subsequent replay of the session. The user selects Send Pidget 1503 to send the stroke information to an intermediate service called Global Paper Look-up Service, which is provided by ANOTO to identify and transfer the pen requests to a registered server. The service then forwards the request to the Servlet component of the TalkingPaper Server which captures all the stroke information.

During replay, the TalkingPaper server retrieves the document from the enterprise database and places it in the exact position where it was originally printed on the paper and synchronizes the sketch and voice. To prevent any data entry errors, e.g., if more than two points are selected, the system will consider this user input as an invalid input and treat the scenario as a non-printed document scenario.

Once the page boundaries have been specified, the next step is to start the TalkingPaper Client. Referring to FIG. 16, the TalkingPaper Client requires the following information from the user to startup:
Folder name where user wants to save the files of this session.
Location on the global file server to put the processed files. In the example shown in FIG. 16, members of a team were grouped according to year and project and were assigned a password protected team space.
Pens participating in the session. TalkingPaper Client also provides, a Java Servlet which captures the Pen IDs of all the pens in an entity, assigns aliases for them such as “pen1”, and stores them in a database. During initialization of the TalkingPaper Client, the Servlet obtains all available “aliases” from the database.
Username associated with a particular pen. This allows different individuals to use the same pen for different meetings. This username can then be used to search a TalkingPaper session or an archive of TalkingPaper sessions for the comments and sketches made by individual(s) associated with that username.

After all the necessary data is entered, the voice recording client is started by way of selecting the “Start Session” button. At this point, the timestamp at the start of the voice recorder is noted. To prevent any data entry errors, the “Start Session” button is not enabled until all the required data has been entered.

Once the voice recorder is started, a dot is drawn on the ANOTO Paper. This intermediation is required to capture the timestamp of the current system time of the digital pen at the session start to manage the inconsistencies in system clock currently present in the digital pen hardware. Otherwise, the inconsistent nature of the system clock of pens would have caused a hindrance because, during replay, the playback applet synchronizes and controls the playback of the sketch stream and audio stream using the timestamps of the stroke captured.

Here, the audio stream is captured by the regular computer system and therefore is very consistent and constant. Since the timestamps of the strokes is captured by the digital pen and since the clock of the pen fluctuates, there is a difference in time between the time the recorder starts and the current time at that moment on the system clock of the pen. This situation is further aggravated by the fact that direct communication cannot be established between the computer system capturing the audio and the digital pen.

To solve this situation, the difference delta between the timestamp of the digital pen and the timestamp of the start of the session is calculated. All the stroke information obtained from the pen is adjusted using this delta. This step can be omitted once the hardware solution to above problem is provided by the pen manufacturers.

As the user begins to sketch on the paper and talks about various issues, the TalkingPaper Client captures all the audio information in an *.asf (advanced streaming format) file. The strokes are captured by the digital pen using a small camera on the pen-tip.

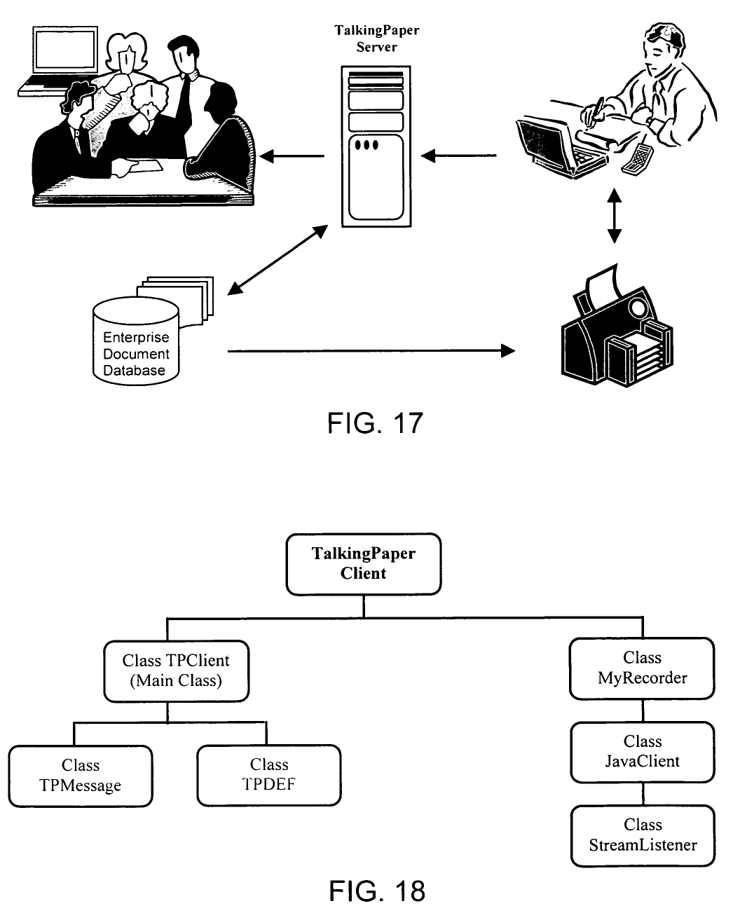

FIG. 17 illustrates the third embodiment of the present invention, implementing a client-server scenario with a single document, a single user, and a single pen. Below describes the TalkingPaper Server processing, which includes a Servlet component, a Socket Server component, and a Post Processing Socket Server Component.

TalkingPaper Server Servlet Component

After the user completed all the sketching actions, he/she sends all the stroke information by clicking on the send pidget, similar to the one shown in FIG. 15. The request of this pen is directed by the aforementioned Global paper look up service to the TalkingPaper Server Java Servlet. The servlet then collects all the strokes information and their timestamps from the pen with the following steps.

First, the servlet authenticates the request. It then records the ID of the pen using the “PEN” object provided by the ANOTO Java API for digital pens. The servlet stores all the stroke information of a particular pen in a file, which ends with the ID of the pen.

During post processing, the server finds the stroke files for each client using the pen IDs of the pens associated with that client. Since the first digits of the pen ID is common for all the pens, only the last few differentiating digits are used to name the file. For example, the filename may begin with the letter “p”, followed by the ID of the pen.

Next, using the Java API, the servlet gets the “PAGE” object of that pen request using the page address returned by the “PEN” object. It then iterates through the various predefined areas of the page, defined in the PAD file and gets the “PENSTROKES” data structure for the pre-defined “Drawing Area” for that page. It iterates through this data structure to obtain each “PENSTROKE” object and uses this object to record all the stroke information.

Each stroke is considered to be a line with continuous array of points drawn without lifting the pen up from the paper. Each line is broken into line segments which consist of two points that make up that particular segment. The x-coordinates, y-coordinates and time stamps of each such line segment along with the timestamp obtained from the “PENSTROKE” object of each stroke are recorded in the corresponding stroke file created for that pen.

TalkingPaper Server Socket Server Component

Once the confirmation of the receipt of the stroke information is received from the server, the user can close the TalkingPaper Client by clicking the “Close Session” button, shown in FIG. 16. At this point, the TalkingPaper Client stores the raw voice data as an “asf” (advanced streaming format) file and communicates with the TalkingPaper Server using the socket protocol to upload this file.

TalkingPaper Sever Post Processing Socket Server Component

When the server receives a client request, it creates a new “TPServerThread” object for each request. This thread performs the post processing for that client. As such, this architecture has multiple threads supporting multiple concurrent clients.

Based on the info message received from the client, the server takes the appropriate actions using the “TPServPostProcess” object. For example, if the information message reads “need the available pen aliases from the database”, then it sends a list of all available aliases. If the information message reads “ready for post-processing”, then it writes the raw audio data to a file and starts the post processing phase.

In the post-processing phase, first, the document image for the current session is retrieved from the enterprise document database. This could be done by using the JAVA JDBC protocol, in which case, the JAVA.ORACLE.* JAVA API could be used to connect to the database. The Structured Query Language (SQL) query is used to retrieve the image data as SQL Binary Large Object (BLOB). The JAVA INPUTSTREAM API is used to read all the bytes in the BLOB and saves it to a jpg image file.

An empty BACKGROUND IMAGE object of the size of the ANOTO paper is first created. In this example, the JAVA.AWT.PIXELGRABBER JAVA API is used to extract all the pixels of this image. These pixels are then initialized to RGB value of white color and stored in a two dimensional array. The file containing the image from the database is read into a memory buffer. Using the AFFINE TRANSFORMATION JAVA API the image is re-sized according to boundaries of printed area recorded initially. The pixels of the resized image are then extracted using the PIXEL GRABBER JAVA API and also stored in two a dimensional array. Using array transformations, the pixels in the background image at the image location recorded initially are replaced with pixels of the resized image and a new image is created. The BACKGROUND IMAGE object stores this new image and also records the timestamp of the image. This timestamp decides when the image will appear during the replay of the session.

The data-points information recorded earlier is converted to TalkingPaper objects. Each pair of data-points is first converted into TalkingPaper LineSegment object and stored along with its timestamp.

LineSegment objects are implemented such that they possess functionality to convert each set of their data points into graphic two dimensional Java Line objects. This graphic can then be drawn on any Java graphic objects like TalkingPaper canvas. All such line segments are grouped according to the line stroke they belong to and stored in a LineStroke object. The timestamp for the strokes is also recorded. All the line strokes belonging to the session are stored, e.g., in TalkingPaper data structure, and sorted according to their timestamps. All these objects along with the image objects are then saved as a java applet. A Web page is created to embed this java applet and is instantaneously published on the global file server to the local machine.

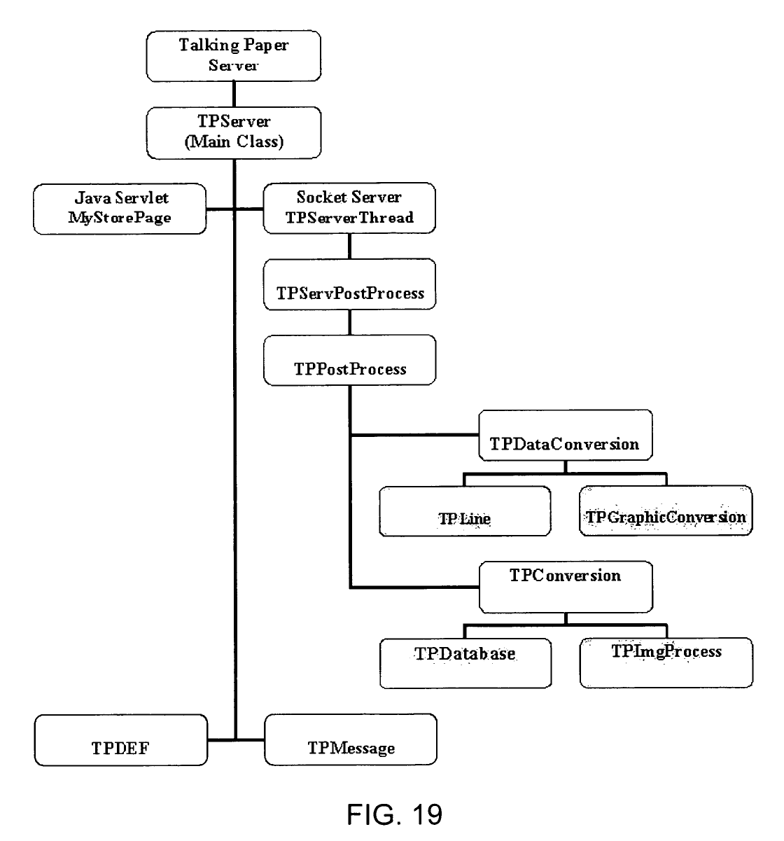

FIG. 18 and FIG. 19 respectively illustrates the TalkingPaper Client object class hierarchy, in order of their call hierarchy and the TalkingPaper Server object class hierarchy, in order of their call hierarchy, respectively. Classes of the TalkingPaper Client object class hierarchy are described below, followed by classes of the TalkingPaper Server object class hierarchy.

TPCIient: This class stores contains GUI components for the TalkingPaper Client application. Referring to the exemplary GUI shown in FIG. 16, the GUI contains three portions. This could be done by using the Java JPanel. The first portion or panel contains textboxes (Java JTextField) that accept user input necessary to gain access to the global file server, e.g., year, team space, session name, login, and password. The second panel contains checkboxes (Java JCheckBox) to select the pen “aliases” participating in the session and textboxes to enter the name of user using that particular pen. The third panel contains buttons (Java JButton) to start and close the client session. The class also contains the Java Socket object to connect to TalkingPaper Socket Server.

TPMessage: This class is the protocol used for communication between the server and the client. TPMessage contains the following information:
The message for the action the client wants the server to take. Currently, there are two types of messages: “need the available pen aliases from the database” and “ready for post-processing”.
The IP address of the client.
The location where the voice file is to be stored on the server.
The list of pens that participated in this session.
The user information (session name, year, login, and password for the global file server).
A memory buffer storing the entire voice file is stored as bytes of data.

TPDEF: This class stores information regarding the folder location where the pen data needs to be stored and other static constants.

MyRecorder: This class directly controls a media encoder and communicates to the TalkingPaper Encoding Server (JavaClient) to start recording. It also writes the encoded media file into the working directory in the media server.

JavaClient and StreamListener: These classes enable audio signals continuously flowing through the input devices during the session to be fed into the audio capture card of the encoding computer and recorded as bytes into the memory buffer.

TPServer: This is the main controlling class for the TalkingPaper Server application. The function in this class listens on the socket port for incoming client requests. When the request is received, a new thread called TPServerThread is spawned to process the request.

TPServerThread: The function of this class is to classify the user request by comparing the user information message to the protocols defined in the TPDEF class. Currently, a request can be of the type “need the available pen aliases from the database” or “ready for post processing”. For the former type of request, it sends a list of all available pen “aliases” to the client. For the latter type of request, it writes the raw voice data to a file and starts the post processing phase.

TPDEF: This TalkingPaper Server class contains all the global constants accessed by other classes of the module and protocol definitions for client-server communication.

TPServPostProcess: This class provides an intermediate preprocessing of the strokes to adjust the pen strokes to manage the time difference at the start of session. It reads the time stamp for the start of the TalkingPaper Client and the timestamp of very first stroke of the pen and calculates the difference and add this delta for each stroke. It writes a new file “ts.txt” containing all the adjusted stoke information. It then calls TPPostProcess to continue the post process phase.

TPPostProcess: This class controls most of the post process. If first checks whether a document is printed on the page, calls TPDatabase and TPImgProcess to read the image from the database, and perform the necessary transformations discussed above. It then calls TPDataConversion and TPConversion to process the line stroke and to convert it into a TalkingPaper object.

TPDatabase: This class contains functions defined for connecting to a databases, executing queries, creating an image files, and getting the “aliases” of pens registered in the database.

TPImgProcess: This class contains functions defined for connecting processing image files, performing pixel transformations described above, and resizing or enlarging images.

TPDataConversion, TPLine, and TPGraphicConversion: TPDataConversion cleans up the data file using TPLine before the post process, removing empty strokes or incomplete strokes. It checks to see if timestamps have been recorded for each line segment and line stroke. It parses the data file and collects the x-coordinates and y-coordinates for all the points of a line stroke and creates imaginary line segments as “strings”. It establishes a continuity between line segments by linking the end point of one line segment and the beginning of the next line segment. It specially marks the beginning of the stroke and records its timestamp. This module groups the line-segments belonging to one particular “LineStroke” and writes them to a new file using the TPGraphicConversion class. These files are named preferably in the order of the timestamp of the LineStroke.

TPConversion: This object reads the files produced by TPDataconversion and converts them into TalkingPaper objects. Each “LineStroke” object stores its start point, endpoint, timestamp, and TalkingPaper data structure of LineSegements. The TPCoversion object stores all these LineStrokes into two global data structures—Permanent Log and Current Log.

The Permanent Log is a chronological collection of all the TalkingPaper objects of the sketch session. The data structure used is a Java Vector that has an unlimited size. The Permanent Log contains sufficient information for the session to be completely replayed.

The second data structure is the Current Log of onscreen elements. The Current Log has a data structure identical to the Permanent Log, except that only the current TalkingPaper objects that have appeared on the screen are saved in this Vector. The Current Log of Screen Elements table is used when the screen needs to be redrawn. This is more efficient than going through the entire Permanent Log.

Each page in a TalkingPaper session saves the logged actions in a separate data file (e.g., *.mmr). It also compiles the page into a Web page (e.g., in HTML) in the working directory of a Web server specified by the user. The images are first converted into JPEG graphics and organized chronologically onto the Web page. The data files for each individual page are also included in the working directory of the Web server. The automatically generated Web page also embeds applets for revisiting/recalling the TalkingPaper session.

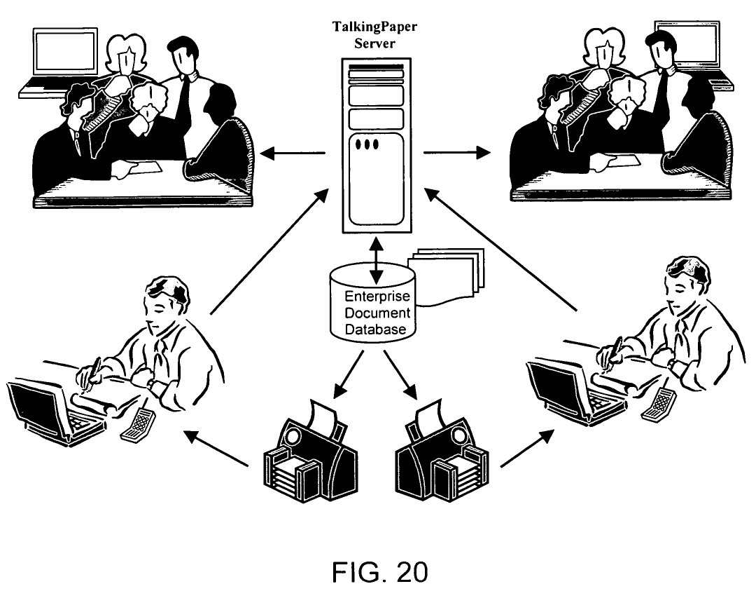

FIG. 20 illustrates the fourth embodiment of the present invention, implementing a multiple clients-server scenario with a single document, a single user, and a single pen per each client. This embodiment provides a multi-client—server system architecture to enable concurrent session creation, capture, indexing, synchronization, and replay streaming of TalkingPaper sessions.

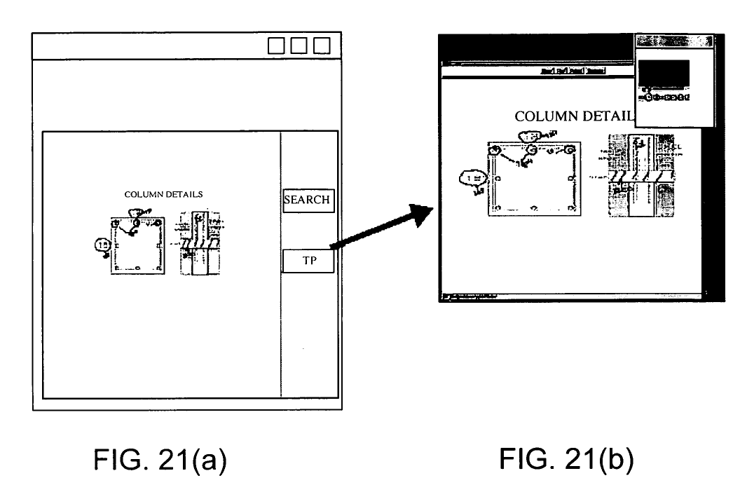

FIG. 21 show snapshots of a TalkingPaper session being replayed via a browser application embedded with a media player. FIG. 21(a) shows a TalkingPaper session archive presented as a Web page of a browser application. From this page, a user can quickly scan through all of the various sketches that were drawn and captured during the production of the session. A user may select a particular sketch from the session and interact in more detail with the sketch as shown in FIG. 21(b). TalkingPaper is not limited by what is shown or described herein and can be readily implemented with any suitable browser applications, media players (plug-ins), media capture/input/output devices, storage devices, client machines, server machines, cellular phones, printers, networks, etc.

By pressing the TalkingPaper (TP) button in FIG. 21(a), two windows pop open, as shown in FIG. 21(b). One window loads the media file from the TalkingPaper Media Server. Another window opens the TalkingPaper java applet which uploads the sketch information from the selected sketch.

The TalkingPaper applet allows users to interact with the captured sketch. Users can elect to play the session which simultaneously plays back the audio/video synchronized with the sketched drawing. In addition, users could select a particular area of the sketch to playback the session only from the point in which that region of the sketch was created.

The TalkingPaper applet instantiates the media player and sends a message to the media player indicating where to look for the media file. The media player contracts the media server and begins to load the media file to prepare for streamed delivery. As the media file is loaded, the TalkingPaper applet begins to download the TalkingPaper data file. This file is located in the same directory from where the TalkingPaper applet is originated.

Once both the media file is ready and the TalkingPaper data file is downloaded, the user can open a window to view the sketch or select an object in the sketch to replay that specific segment of the sketch, audio, and video. The TalkingPaper applet determines the timestamp of the selection and begins replaying both the sketch and the media file from that point on. The TalkingPaper applet communicates with the media player to synchronize the playback and to resolve any buffering that the media player must perform before the playback can commence. This communication continues during the playback to resolve any synchronization issues.

The select rectangle mode is the default on how a region can be selected. TalkingPaper goes through the “Current On Screen Elements Table” and collects a list of TalkingPaper objects that are either contained or intersect the selected region. Currently, the first object (chronologically) is selected by default, if multiple objects are selected by the region. Once the object is selected, its timestamp is accessed and the time information is used to redraw the sketch and start the media player at the correct time offset.

During playback of a TalkingPaper session, two different engines control the playback of the sketch stream and the audio/video stream. The media player engine handles the serving and streaming of the audio/video. The TalkingPaper playback applet communicates with the streamed audio/video to control the playback of the sketch stream and maintain synchronization. This is accomplished by using the streamed audio/video as an absolute time reference. The sketch playback applet constantly polls (10 times/sec) the audio/video stream to query the time. In this manner, the sketch applet can either speed up or slow down to remain synchronized.

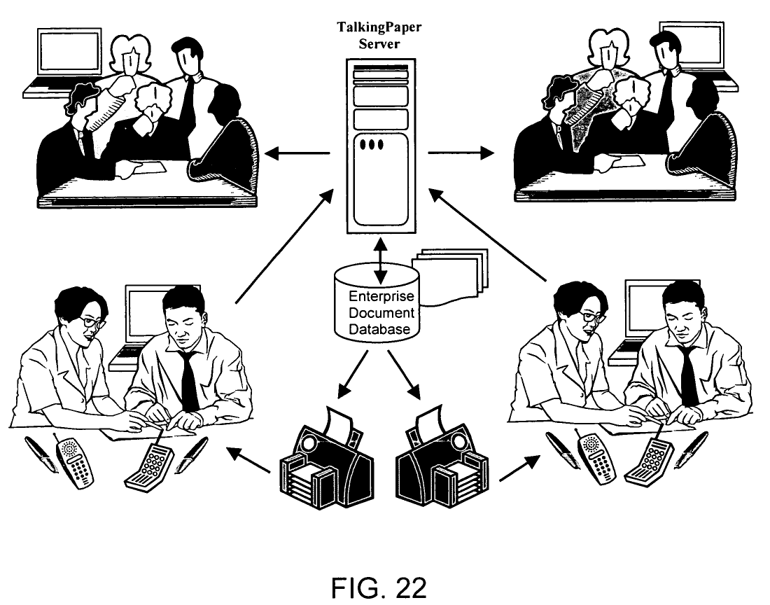

FIG. 22 illustrates the fifth embodiment of the present invention, implementing a multiple clients-server scenario with a single document, multiple users, and multiple pens per each client. This embodiment supports multiple clients, each having multiple users, each of which has his/her own pen sketching and annotating on a blank ANOTO page or a single ANOTO page on which a document is printed. During replay, the embodiment provides a filter mechanism where the user can filter out the sketches, using the name of the people who participated in the production of session.

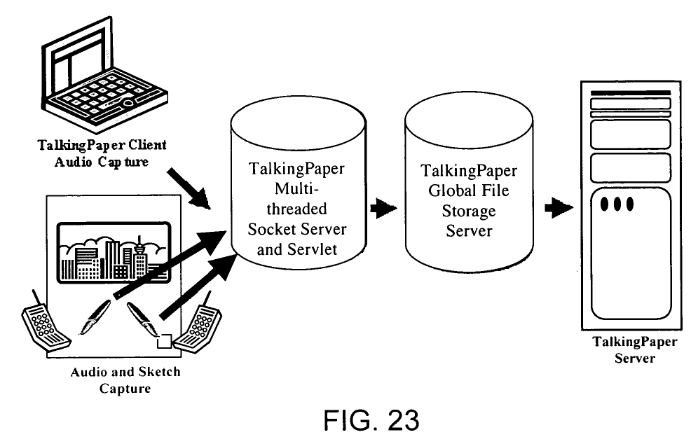

FIG. 23 illustrates the system and components for scenarios involving multiple pens. This embodiment augments the post processing phase to address the following key challenges:
1. Synchronize the system clocks of multiple pens so that during replay the playback applet synchronizes and controls the playback of the sketch stream and audio stream using the timestamps of the stroke captured from each pen. The audio is captured by the regular computer system and therefore is very consistent and constant. The clock of the pens might fluctuate. Consequently, there may be a difference in time between the time the voice recorder starts and the current time at that moment on the system clock of the pen. In addition, there is no direct communication between the digital pens and the client that records the discourse/voice. Therefore, another unknown variable “network delay” must be taken into account.
2. Keep track of the order in which the pens sketched on the paper for synchronization, indexing, and replay purposes.

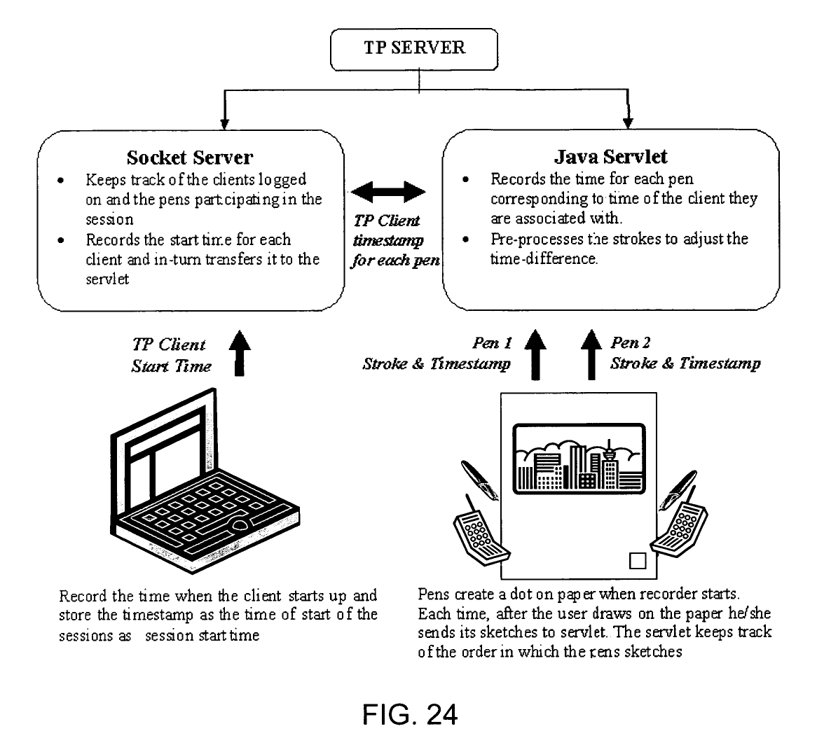

FIG. 24 represents the clock synchronization solution to these challenges. When the TalkingPaper Client starts the voice recorder on a client machine (e.g., a laptop or desktop computer with microphone), it sends the current system time and the IP address of the machine to the Socket Server. Once the voice recorder is started, a dot is drawn on the ANOTO paper by each digital pen participating in that session.

The sketches drawn for one complete TalkingPaper session are broken into small sessions. Each small session starts when a user begins sketching on the ANOTO paper with his/her digital pen and ends when he/she sends this stroke information to the servlet. Therefore, one TalkingPaper session is interweaved with such small sessions for each digital pen's strokes.

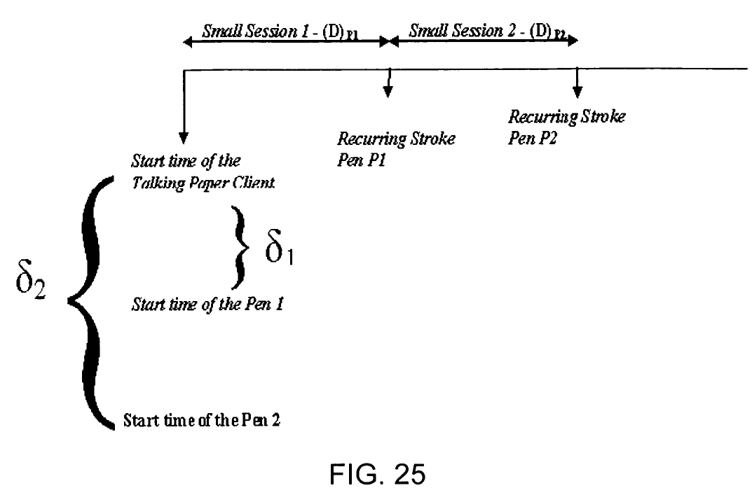

The servlet collects and postmarks the strokes for each small session according to current system time when it receives them. This way, the servlet keeps track of the order in which the digital pens sketched on the ANOTO paper. The very first stroke of each digital pen (i.e., a dot) records the timestamp of the digital pen at the time the TalkingPaper Client was started. This is used to normalize the strokes of the digital pen with respect to the start timestamp of the client with which they are associated. The servlet then sends a message using the socket protocol communication and obtains the start timestamp of TalkingPaper Client associated therewith. The adjustment of the timestamps of the pen strokes is described below with reference to FIG. 25.

We define
(Tₛ)_{C}=Timestamp when the TalkingPaper Client started.
(Tₛ)_{P1}→Timestamp of pen1 when the TalkingPaper Client started.
(Tₛ)_{P2}→Timestamp of pen2 when the TalkingPaper Client started.
(D)_{P1}→Duration of small session of pen1.
(D)_{P2}→Duration of small session of pen2.

For each pen there are two delta differences that need to be calculated. First delta (d₁) is the difference between the start time of TalkingPaper Client and the start time of the pen. That is, d₁=(Tₛ)_{P1}−(Tₛ)_{C}. Similarly, d₂=(Tₛ)_{P2}−(Tₛ)_{C}.

The second difference is the time elapsed from the start of the session until the start of the current small session, i.e., the sum of all the durations of its predecessors. That is,
e₁=0→for pen P1 and
e₂=duration of small session of pen 1 (D)_{P1}→for pen P2.

Therefore, the total delta (TD) by which the timestamps of each pen stroke for each digital pen need to be adjusted is
TD=d+e. Thus,
Pen 1:TD₁=d₁+e₁, and
Pen 2 TD₂=d₂+e₂.

All the stroke timestamps of each pen is adjusted using this total delta (TD). The servlet then saves all the strokes along with the postmark timestamp in a file named “p” followed by the pen ID of the pen as in the example described above. The post-processing component then reads all these files and writes them to a new file in the order according to the postmarked timestamp. This new file is used to convert the stroke information into TalkingPaper objects. From there on, post processing proceeds as described before.

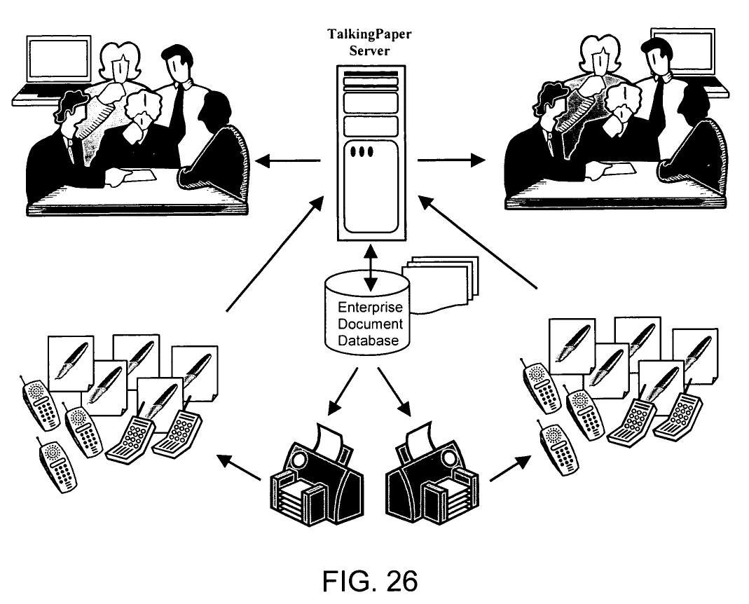

FIG. 26 illustrates the sixth embodiment of the present invention, implementing a multiple clients-server scenario. This embodiment exemplifies the last scenario illustrated in FIG. 3—reflection-in-interaction where there are multiple documents, multiple users, and multiple pens per each client.

In this embodiment, multiple documents stored in an enterprise database are printed on separate ANOTO paper pages. Paper IDs are implemented and used as unique identifiers of the different pages and the corresponding documents printed on them together with the annotations or sketches that mark up these documents. As different items are annotated on different pages, TalkingPaper keeps track of the strokes using the Paper ID, its corresponding image/document, and the time these strokes are made. During subsequent replay, TalkingPaper retrieves the corresponding documents from the enterprise database and synchronize them with the sketch strokes and voice, thus providing a contextualized record in the original sequence where the annotations and discourse took place.

Most digital computer systems can be programmed to perform the invention disclosed herein. To the extent that a particular computer system configuration is programmed to implement the present invention, it becomes a digital computer system within the scope and spirit of the present invention. The necessary programming-related techniques are well known to those skilled in the art and thus are not further described herein for the sake of brevity.

Computer programs implementing the present invention can be distributed to users on a computer-readable medium such as floppy disk, memory module, or CD-ROM and are often copied onto a hard disk or other storage medium. When such a program of instructions is to be executed, it is usually loaded either from the distribution medium, the hard disk, or other storage medium into the random access memory of the computer, thereby configuring the computer to act in accordance with the inventive method disclosed herein. All these operations are well known to those skilled in the art. The term “computer-readable medium” encompasses distribution media, intermediate storage media, execution memory of a computer, and any other medium or device capable of storing for later reading by a computer a computer program implementing the invention disclosed herein.

Although the present invention and its advantages have been described in detail, it should be understood that the present invention is not limited to or defined by what is shown or discussed herein. The tables, description and discussion herein illustrate technologies related to the invention, show examples of the invention and provide examples of using the invention. Known methods, procedures, systems, elements, or components may be discussed without giving details, so to avoid obscuring the principles of the invention.

One skilled in the art will realize that implementations of the present invention could be made without departing from the principles, spirit, or legal scope of the present invention. For example, TalkingPaper can be used as a standalone module or can be integrated into another pen and paper-based system or environment. Accordingly, the scope of the present invention should be determined by the following claims and their legal equivalents.

1. A method of reusing data captured by one or more pen, said method comprising:
enabling one or more user to start and end a session involving said pen capturing said data;
receiving said data from said pen; wherein said data comprise line strokes and a media stream;
processing said data into TalkingPaper objects;
associating, indexing, and synchronizing said TalkingPaper objects with said media stream; and
enabling one or more user to select, search, retrieve, and replay said session from any point of interest thereof.

2. The method of claim 1, comprising:
registering a TalkingPaper application service handler with a network paper lookup service server; and
configuring a wireless device for forwarding look up requests received from said pen to said network paper lookup service server.

3. The method of claim 1, wherein said processing step further comprising:
extracting line stroke definition and corresponding timestamp from each of said line strokes; and
for each of said line strokes, initializing a TalkingPaper object with said line stroke definition and said corresponding timestamp.

4. The method of claim 3, wherein
said line stroke definition includes start and end coordinates of each of said line strokes.

5. The method of claim 1, further comprising:
archiving said session with said synchronized TalkingPaper objects and media stream.

6. The method of claim 1, further comprising:
archiving and distributing said session with said synchronized TalkingPaper objects and media stream.

7. The method of claim 1, wherein
said media stream is a voice stream.

8. The method of claim 1, further comprising:
recording and tracking what document page or pages, image or image are printed on a piece of paper.

9. The method of claim 8, further comprising:
retrieving a desired document page or image; and
synchronizing said document page or image with said TalkingPaper objects and said media stream.

10. The method of claim 9, further comprising:
retrieving a desired document page or image;
synchronizing said document page or image with said TalkingPaper objects and said media stream; and
displaying said document page or image at a location on a screen page that is the same as it was printed on said piece of paper.

11. The method of claim 10, further comprising:
keeping track of different document pages or images and one or more sequences of sketches made thereon.

12. The method of claim 1, further comprising:
streaming said session with said synchronized TalkingPaper objects and media stream over a distributed network, enabling concurrent replaying of said session over said network.

13. The method of claim 1, further comprising:
storing and keeping track of one or more username or one or more pen ID that are linked with specific sketch activities.

14. A computer system programmed to implement the method steps of claim 1.

15. A program storage device accessible by a computer, tangibly embodying a program of instructions executable by said computer to perform the method steps of claim 1.

16. A system for knowledge capture and reuse, said system comprising:
one or more digital pen and one or more programmable paper pages for capturing sketching activities and an audio/video stream, wherein said sketching activities comprise individual line strokes;
a client application residing in one or more client machines for
enabling one or more user to record said sketching activities and said audio/video stream during a session; and
enabling one or more user to select, search, retrieve, and replay said session from any point of interest thereof; and
a multi-threaded application server for
converting said sketching activities into sketch objects; and
associating, indexing, and synchronizing individual sketch objects with corresponding segments of said audio/video stream.

17. The system of claim 16, further comprising:
a database for storing said captured sketching activities and audio/video stream.

18. The system of claim 16, further comprising:
a database for storing said sketch objects, wherein each of said sketch objects contains a line stroke definition and a corresponding timestamp extracted from each of said line strokes.

19. The system of claim 16, further comprising:
one or more wireless device for receiving look up requests from said digital pen and for forwarding said requests to a network paper lookup service server containing a network address of said multi-threaded application server.

20. The system of claim 16, wherein
said client application comprises a user interface implemented in a browser application embedding a media player.
